(19) United States
(12) Patent Application Publication
(10) Pub. No.: US 2022/0243049 A1
(43) Pub. Date: Aug. 4, 2022

(54) POLYMERIC COMPOSITION, AQUEOUS ACRYLIC RESIN HAVING HIGH SOLVENT RESISTANCE, AND METHOD FOR MANUFACTURING THE SAME

(71) Applicant: NAN YA PLASTICS CORPORATION, Taipei (TW)

(72) Inventors: TE-CHAO LIAO, TAIPEI (TW); SEN-HUANG HSU, TAIPEI (TW); Hui-Chun Chuang, TAIPEI (TW)

(21) Appl. No.: 17/393,670

(22) Filed: Aug. 4, 2021

(30) Foreign Application Priority Data
Jan. 29, 2021 (TW) 110103364

(51) Int. Cl. C08L 33/06; C08J 5/18

(52) U.S. Cl. CPC C08L 33/066; C08J 5/18; C08J 2483/06; C08L 2203/16; C08J 2333/12; C08L 2201/52

(57) ABSTRACT

A polymeric composition, aqueous acrylic resin having high solvent resistance and a method for manufacturing the same, are provided. The polymeric composition includes an acrylic monomer polymer, an epoxy-containing silane and a reactive emulsifier. A weight ratio of the acrylic monomer polymer, the epoxy-containing silane and the reactive emulsifier is 100:1:3. The epoxy-containing silane is 1 to 3 wt % of (3-glycidoxypropyl) trimethoxy silane and/or 1 to 3 wt % of (3-glycidoxy propyl) methyl diethoxy silane.

### CROSS-REFERENCE TO RELATED PATENT APPLICATION

This application claims the benefit of priority to Taiwan Patent Application No. 110103364, filed on Jan. 29, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an aqueous acrylic resin that can be used in artificial leathers, and more particularly to a polymeric composition, an aqueous acrylic resin having high solvent resistance, and a method for manufacturing the same, which relate to the technical field of manufacturing and processing artificial leathers.

### BACKGROUND OF THE DISCLOSURE

Synthetic leather is formed by having one or more layers of polyurethane (PU) or polyvinyl chloride (PVC) laminated onto a cloth substrate, and is an ideal replacement for real leather. Nowadays, synthetic leather products have become indispensable to our daily lives. However, certain properties of the synthetic leather are inferior to those of real leather. Thus, a treating agent is used to form a coating on a surface of the synthetic leather, so as to allow the synthetic leather to have properties that are similar to or better than those of real leather.

Most treating agents used by both foreign and domestic synthetic leather manufacturers are solvent-based treating agents. Since the solvent-based treating agents contain toxic and harmful organic solvents (such as toluene), a large quantity of volatile organic compounds (VOCs) is produced during the manufacturing or use of the synthetic leather, and is harmful to the environment and human health. In order to solve this problem, the synthetic leather manufacturers have begun using water-based treating agents as a substitute for the solvent-based treating agents. However, while the water-based treating agents can be used in the production of the synthetic leather and have the advantage of being resistant to rubbing, abrasion and water, the water-based treating agents still have the disadvantage of exhibiting poor solvent resistance, especially to acetone. Therefore, there is still room for improvement in water-based treating agents.

### SUMMARY OF THE DISCLOSURE

In response to the above-referenced technical inadequacy, the present disclosure provides polymeric composition, an aqueous acrylic resin having high solvent resistance and a method for manufacturing the same. A molecular structure of the aqueous acrylic resin contains a greater number of epoxy groups, reactive emulsifiers, etc. Accordingly, a cohesive force and a cross-linking degree of the aqueous acrylic resin can be significantly increased, which results in higher solvent resistance.

In one aspect, the present disclosure provides a polymeric composition which is used for forming an aqueous acrylic resin having high solvent resistance. The polymeric composition includes: an acrylic monomer polymer, an epoxy-containing silane and a reactive emulsifier. A weight ratio of the acrylic monomer polymer, the epoxy-containing silane and the reactive emulsifier is 100:1:3.

In certain embodiments, the epoxy-containing silane is selected from the group consisting of (3-glycidoxypropyl) trimethoxy silane, (3-glycidoxy propyl) methyl diethoxy silane, 2-(3, 4-epoxycyclohexyl) ethyl trimethoxy silane, (3-glycidoxy propyl) methyl dimethoxy silane, and (3-glycidoxy propyl) triethoxy silane.

In certain embodiments, based on 100 wt % of the acrylic monomer polymer, the epoxy-containing silane includes: 1 to 3 wt % of (3-glycidoxypropyl) trimethoxy silane and/or 1 to 3 wt % of (3-glycidoxy propyl) methyl diethoxy silane.

In certain embodiments, based on 100 wt % of the acrylic monomer polymer, the acrylic monomer polymer includes: 55 to 65 wt % of alkyl group-containing methyl acrylate, 20 to 30 wt % of hydroxyl group containing methyl acrylate, 1 to 5 wt % of carboxyl group containing methacrylic acid, and 8 to 18 wt % of alkene-based unsaturated group containing methyl acrylate.

In certain embodiments, the alkyl group-containing methyl acrylate is selected from the group consisting of methyl methacrylate, ethyl acrylate, propyl methacrylate, butyl acrylate, isobutyl methacrylate, pentyl methacrylate, hexyl methacrylate, heptyl methacrylate, octyl methacrylate, 2-ethylhexyl methacrylate, n-octyl methacrylate, iso-octyl methacrylate, nonyl methacrylate, decyl methacrylate, lauryl methacrylate, octadecyl methacrylate, methoxyethyl methacrylate, n-butyl methacrylate, 2-ethylhexyl acrylate, and ethoxymethyl acrylate.

In certain embodiments, the hydroxyl group containing methyl acrylate is selected from the group consisting of 2-hydroxyethyl (meth)acrylate, 4-hydroxybutyl (meth)acrylate, 2-hydroxypropyl chloroacrylate and diethylene glycol mono(meth)acrylate.

In certain embodiments, the carboxyl group containing methacrylic acid is selected from the group consisting of acrylic acid, methacrylic acid, maleic acid, fumaric acid, itaconic acid, butenoic acid, and maleic anhydride.

In certain embodiments, the alkene-based unsaturated group containing methyl acrylate is selected from the group consisting of vinyl acetate, styrene, methyl styrene, vinyl toluene, methacrylonitrile, diacetone acrylamide, N-hydroxymethyl acrylamide, cyclohexyl methacrylate, and isobornyl methacrylate.

In another aspect, the present disclosure provides an aqueous acrylic resin having high solvent resistance, including the polymeric composition of the present disclosure.

In yet another aspect, the present disclosure provides a manufacturing method of an aqueous acrylic resin having high solvent resistance. The method includes: forming a starting reactant in a reaction tank, the starting reactant including a deionized water, a buffer and an emulsifier; forming a pre-emulsion including an acrylic monomer polymer, an epoxy-containing silane and a reactive emulsifier in a weight ratio of 100:1:3; and adding the pre-emulsion to the starting reactant to carry out a reaction.

In certain embodiments, the method further includes: maintaining the temperature of the reaction tank at 70° C. to 80° C., and adding a hydrophilic initiator in the reaction tank.

In certain embodiments, the buffer is sodium bicarbonate or ammonium bicarbonate, and the emulsifier is sodium dodecylbenzene sulfonate.

In certain embodiments, in the step of adding the pre-emulsion to the starting reactant to carry out a reaction, a temperature under which the step is performed is 70° C. to 80° C., and the pre-emulsion is added in a dropwise manner.

In certain embodiments, a surface treatment material for synthetic leathers is provided, and the surface treatment material can have different forms, such as a surface treatment agent, a surface treatment coating or a surface treatment film. The surface treatment material for synthetic leathers includes an aqueous acrylic resin having high solvent resistance, which is formed by the polymeric composition of the present disclosure. The polymeric composition includes: an acrylic monomer polymer, an epoxy-containing silane and a reactive emulsifier. A weight ratio of the acrylic monomer polymer, the epoxy-containing silane and the reactive emulsifier is 100:1: 3. The epoxy-containing silane is (3-glycidoxypropyl) trimethoxy silane and/ or (3-glycidoxy propyl) methyl diethoxy silane. Based on 100 wt % of the acrylic monomer polymer, the acrylic monomer polymer includes: 55 to 65 wt % of alkyl group-containing methyl acrylate, 20 to 30 wt % of hydroxyl group containing methyl acrylate, 1 to 5 wt % of carboxyl group containing methacrylic acid, and 8 to 18 wt % of alkene-based unsaturated group containing methyl acrylate.

Therefore, one of the beneficial effects of the present disclosure is that, in the polymeric composition, the aqueous acrylic resin having high solvent resistance, and the method for manufacturing the same provided by the present disclosure, an aqueous acrylic resin having improved solvent resistance can be formed through bonding the epoxy-containing silane and the reactive emulsifier to an acrylic polymer and adding functional reactive monomers. Moreover, the aqueous acrylic resin can be used in the production of synthetic leathers, so as to reduce emission of volatile organic compounds (VOC), and to meet physical property requirements of the synthetic leathers.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of an aqueous acrylic resin having high solvent resistance according to an embodiment of the present disclosure; and

FIG. 2 is a flowchart of a method for manufacturing the aqueous acrylic resin having high solvent resistance according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The term “wt %” herein, unless specified otherwise, refers to a percentage of a compound based on a weight of the compound relative to a total weight of a solution embodying said specified compound. Unless the context of use clearly indicates otherwise, any percentages not mentioned specifically herein shall be constituted by weight % or wt %.

The term “polymer” herein, unless specified otherwise, individually includes polymers, oligomers, copolymers, tripolymers, block copolymers, segment copolymers, prepolymers, graft copolymers, and any mixture or combination thereof.

As a substitution for real leathers, synthetic leathers have an extremely wide range of application. Therefore, the present disclosure provides a polymeric composition, which can be formed into an aqueous acrylic resin via an emulsion polymerization reaction, so as to increase the applicability of an aqueous treating agent for treating a surface of the synthetic leathers.

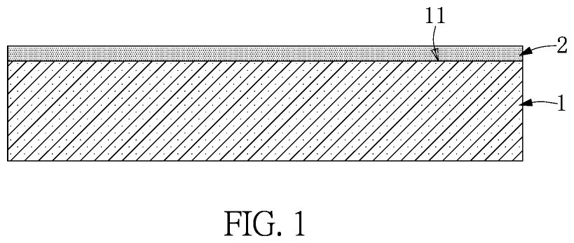

Referring to FIG. 1, in practice, the aqueous treating agent that includes the aqueous acrylic resin formed by the polymeric composition of the present disclosure can form into a uniform coated layer 2 on a surface 11 of a synthetic leather 1 (such as a PVC synthetic leather or a PU synthetic leather). Accordingly, physical properties of the synthetic leather 1 can be improved, especially with respect to solvent resistance and acetone resistance. Furthermore, a recipe of the aqueous treating agent can be adjusted to allow the synthetic leather 1 to have a special appearance and texture. It is worth mentioning that when the aqueous acrylic resin is used in the production of the synthetic leather 1, emission of volatile organic compounds (VOC) is significantly reduced due to water being used as a dispersion medium, and requirements of environmental protection regulations can be satisfied. In addition, the aqueous acrylic resin with a higher solvent resistance is better adapted for a production process of the synthetic leather 1.

The polymeric composition of the present disclosure includes an acrylic monomer polymer, an epoxy-containing silane and a reactive emulsifier. A weight ratio of the acrylic monomer polymer, the epoxy-containing silane and the reactive emulsifier is 100:1:3.

In one embodiment, the epoxy-containing silane can be selected from the group consisting of (3-glycidoxypropyl) trimethoxy silane, (3-glycidoxy propyl) methyl diethoxy silane, 2-(3, 4-epoxycyclohexyl) ethyl trimethoxy silane, (3-glycidoxy propyl) methyl dimethoxy silane, and (3-glycidoxy propyl) triethoxy silane.

In one embodiment, based on 100 wt % of the polymeric composition, the acrylic monomer polymer includes: 1 to 3 wt % of (3-glycidoxypropyl) trimethoxy silane and/or 1 to 3 wt % of (3-glycidoxy propyl) methyl diethoxy silane.

In one embodiment, the acrylic monomer polymer includes: 55 to 65 wt % of alkyl group-containing methyl acrylate, 20 to 30 wt % of hydroxyl group containing methyl acrylate, 1 to 5 wt % of carboxyl group containing methacrylic acid, and 8 to 18 wt % of alkene-based unsaturated group containing methyl acrylate.

In one embodiment, the alkyl group-containing methyl acrylate can be selected from the group consisting of methyl methacrylate, ethyl acrylate, propyl methacrylate, butyl acrylate, isobutyl methacrylate, pentyl methacrylate, hexyl methacrylate, heptyl methacrylate, octyl methacrylate, 2-ethylhexyl methacrylate, n-octyl methacrylate, iso-octyl methacrylate, nonyl methacrylate, decyl methacrylate, lauryl methacrylate, octadecyl methacrylate, methoxyethyl methacrylate, n-butyl methacrylate, 2-ethylhexyl acrylate, and ethoxymethyl acrylate. However, such examples are not intended to limit the present disclosure. The alkyl group-containing methyl acrylate can be used to adjust a molecular structure of the aqueous acrylic resin. Therefore, the aqueous acrylic resin can have an appropriate glass transition temperature (Tg), and is helpful for improving physical properties of the coated layer 2, such as hardness, gloss, fullness, weather resistance, and adhesion to a substrate.

The hydroxyl group containing acrylic polyester polyol and/or the hydroxyl group containing acrylic polyether polyol can be selected from products of Dow Chemical Company, such as SPECFLEX™ NC 630, SPECFLEX™ NC 701, VORANOL™ 2070, VORANOL™ 3943A, VORANOL™ HL431, VORANOL™ HN395, VORANOL™ HF4001, VORANOL™ WH4043, and VORANOL™ CP6001. However, such examples are not intended to limit the present disclosure. The hydroxyl group containing acrylic polyester polyol and/or the hydroxyl group containing acrylic polyether polyol can be used to increase the adaptability of a coating (i.e., the aqueous treating agent) to different substrates, and to allow the coated layer 2 to have desired properties (such as flexibility, high hardness, high gloss, and high adhesion). However, such examples are not intended to limit the present disclosure.

The carboxyl group containing methacrylic acid can be selected from the group consisting of acrylic acid, methacrylic acid, maleic acid, fumaric acid, itaconic acid, butenoic acid, and maleic anhydride. However, such examples are not intended to limit the present disclosure. The carboxyl group containing methacrylic acid can provide carboxyl groups to the molecular structure of the aqueous acrylic resin, in which the carboxyl groups carrying negative charges can produce an adsorption effect with respect to substances carrying positive charges (such as positively charged inorganic particles). The carboxyl groups can also serve as a bridging point for increasing intermolecular forces, thereby increasing the mechanical strength of the coated layer 2. Furthermore, the carboxyl group containing methacrylic acid can be used to increase the adhesion of the coated layer 2 with respect to the substrate.

The alkene-based unsaturated group containing methyl acrylate can be selected from the group consisting of vinyl acetate, styrene, methyl styrene, vinyl toluene, methacrylonitrile, diacetone acrylamide, N-hydroxymethyl acrylamide, cyclohexyl methacrylate, and isobornyl methacrylate. However, such examples are not intended to limit the present disclosure. The alkene-based unsaturated groups can be used to improve the physical properties of the coated layer 2, such as hardness, heat resistance, alcohol resistance, weather resistance, and adhesion to a substrate.

The reactive emulsifier of the polymeric composition of the present disclosure can be selected from an emulsifier known as “SR-10” that is available from ADEKA Corporation, an emulsifier known as “PC-10” that is available from Sanyo Chemical Industries, Ltd., and emulsifiers known as “NOIGEN RN-20”, “NOIGEN RN-30” and “NOIGEN RN-50” that are available from Chin Yee Chemical Industries Co., Ltd.

Furthermore, the polymeric composition of the present disclosure can perform the emulsion polymerization reaction in an aqueous resin system, in which a functional monomer and the reactive emulsifier are bonded together to form the molecular structure of the aqueous acrylic resin. In certain embodiments, the starting reactant is the aqueous resin system that includes deionized water, a buffer, an emulsifier, and an initiator. The buffer is sodium bicarbonate or ammonium bicarbonate. Moreover, the emulsifier is sodium dodecylbenzene sulfonate (SDBS), and the initiator is sodium persulfate (SPS). However, such examples are not intended to limit the present disclosure.

In addition, additives may be included optionally. For example, the additives can be: a matting agent, a urethane catalyst, a neutralizing agent, a crosslinking agent, a silane coupling agent, a tackifier, a filler, a thixotropic agent, an adhesive agent, paraffin, a heat stabilizer, a light resistance stabilizer, a fluorescent whitening agent, a foaming agent, a pigment, a dye, a conductivity imparting agent, an antistatic agent, a moisture permeability enhancer, a water repellent, an oil repellent, a hollow foam body, a flame retardant, a water absorbing agent, a moisture absorbing agent, a deodorant, a foam stabilizer, an anti-caking agent, an anti-hydrolysis agent, etc. These additives can be used individually, or two or more in combination.

In more detail, the matting agent can be, for example, resin particles, silica particles, talc, aluminum hydroxide, calcium sulfate, calcium silicate, calcium carbonate, magnesium carbonate, barium carbonate, alumina silicate, a molecular sieve, kaolin and mica, etc.

The present disclosure further provides an aqueous acrylic resin having high solvent resistance, which is formed by the polymeric composition including the above-mentioned functional monomer and reactive emulsifier.

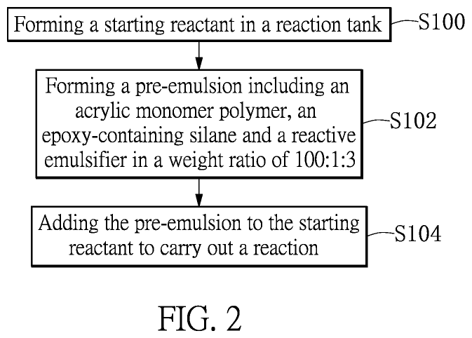

The present disclosure further provides a manufacturing method of an aqueous acrylic resin having high solvent resistance. Referring to FIG. 2, the aqueous acrylic resin having high solvent resistance of the present disclosure is made according to the following steps: forming a starting reactant in a reaction tank (step S100), the starting reactant including a deionized water, a buffer and an emulsifier; forming a pre-emulsion including an acrylic monomer polymer, an epoxy-containing silane and a reactive emulsifier in a weight ratio of 100:1:3 (step S102); and adding the pre-emulsion to the starting reactant to carry out a reaction (step S104).

Specifically, in step S100, firstly, the deionized water, the buffer, and the emulsifier are added into the reaction tank according to the predetermined weight ratio and are stirred uniformly to obtain the starting reactant. After a temperature in the reaction tank is increased to a first temperature (such as 70 to 80° C.), a predetermined amount of a hydrophilic initiator aqueous solution is added to the starting reactant, and stirred continuously for 10 minutes.

In step S102, firstly stir and mix the deionized water and a polymeric composition to form a pre-emulsion, the polymeric composition includes an acrylic monomer polymer, an epoxy-containing silane and a reactive emulsifier in a weight ratio of 100:1:3.

In step S104, the pre-emulsion is added to the reaction tank at a temperature of 70 to 80° C. in a dropwise manner. After 30 minutes of reaction, a predetermined amount of a second initiator aqueous solution is added dropwise (time: controlled to be within 4 hours), and the temperature is raised to 80° C. to react for 2 hours. After the reaction, the temperature in the reaction tank is cooled to about 40 to 42° C., and the reaction is continued for a period of time. Then, the buffer is added to adjust the pH value of the resulting product to pH 7-8. Finally, the product is cooled to room temperature.

### Embodiment 1

The starting reactant is added to the reaction tank to be mixed uniformly. After the temperature in the reaction tank is raised to 75° C., a first hydrophilic initiator is added and stirred continuously for 10 minutes. 37 parts by weight of the deionized water, 3 parts by weight of the reactive emulsifier SR-10, 3 parts by weight of the epoxy-containing silane and 3 parts by weight of the acrylic monomer polymer are mixed uniformly by a mixer, so as to form a pre-emulsion. The temperature is maintained at 75° C., and the pre-emulsion is added to the reaction tank in a dropwise manner After 30 minutes of reaction, the aqueous solution formed by a second hydrophilic initiator is added dropwise to the reaction tank (time: controlled to be within 4 hours), and the temperature is raised to 80° C. to react for 2 hours. After the reaction, the temperature in the reaction tank is cooled to below 40° C. Then, ammonia is added to adjust the pH value of the resulting product to pH 7-8. Finally, the product is cooled to room temperature. The compositions of the polymeric composition are shown in Table 1.

A calculated solid content of a product obtained by the preparing process is 43% by weight. The product is formed into a film, whose physical properties are tested and shown in Table 2.

### Embodiment 2

The reaction process of Embodiment 2 is the same as that of Embodiment 1. What is different is that in Embodiment 2, the polymeric composition contains 1 part by weight of 3-glycidoxypropyl) methyldiethoxysilane (KBE402). The compositions of the polymeric composition are shown in Table 1. After the reaction, the calculated solid content of a product obtained by the preparing process is 43% by weight. The product is formed into a film, whose physical properties are tested and shown in Table 2.

### Embodiment 3

The reaction process of Embodiment 3 is the same as that of Embodiment 1. What is different is that in Embodiment 3, the polymeric composition contains 0.5 parts by weight of 3-glycidoxypropyl) trimethoxysilane and 0.5 parts by weight of (3-glycidoxypropyl) methyldiethoxysilane. The compositions of the polymeric composition are shown in Table 1. After the reaction, the calculated solid content of a product obtained by the preparing process is 43% by weight. The product is formed into a film, whose physical properties are tested and shown in Table 2.

### Comparative Embodiment 1

The reaction process of Comparative Example 1 is the same as Embodiment 1. What is different is that in Comparative Example 1, a monomer composition of the polymeric composition is alkoxy-containing organosilicon (i.e., Dow Corning's XIAMETER® OFS-6030 Silane, whose composition is γ-methacryloxypropyltrimethoxysilane), and the reactive emulsifier of the polymeric composition is the reactive emulsifier PC-10. The compositions of the polymeric composition are shown in Table 1. After the reaction, the calculated solid content of a product obtained by the preparing process is 43% by weight. The product is formed into a film, the properties of which are tested and shown in Table 2.

TABLE 1

| | | | | | | | Comparative |
|---|---|---|---|---|---|---|---|
| | | | | Embodiment | Embodiment | Embodiment | Embodiment |
| Composition | | | | 1 | 2 | 3 | 1 |
| Starting | Deionized water | | | 70 | 70 | 70 | 70 |
| reactant | Sodium bicarbonate | | | 0.28 | 0.28 | 0.28 | 0.285 |
| | Ammonium Bicarbonate | | | 0.08 | 0.08 | 0.08 | 0.08 |
| | Anion emulsifier SDBS | | | 3 | 3 | 3 | 3 |
| First | Deionized water | | | 3 | 3 | 3 | 3 |
| hydrophilic | SPS | | | 0.3 | 0.3 | 0.3 | 0.3 |
| initiator | | | | | | | |
| Pre- | Deionized water | | | 37 | 37 | 37 | 37 |
| emulsion | epoxy-containing silane | | KBM403 | 1 | — | 0.5 | — |
| | | | KBE402 | — | 1 | 0.5 | — |
| | Alkoxy-containing silane | | OFS-6030 | — | — | — | 1 |
| | Reactive emulsifier | | SR-10 | 3 | 3 | 3 | — |
| | | | PC-10 | — | — | — | 3 |
| | Acrylic | (A)Alkyl group- | MMA | 30 | 30 | 30 | 30 |
| | monomer | containing methyl | BMA | 14 | 14 | 14 | 14 |
| | | acrylate | BA | 8 | 8 | 8 | 8 |
| | | | 2EHA | 7 | 7 | 7 | 7 |
| | | (B)Hydroxy- | 2-HEMA | 25 | 25 | 25 | 25 |
| | | containing | | | | | |
| | | (meth)acrylate | | | | | |
| | | (C)Carboxyl | AA | 2 | 2 | 2 | 2 |
| | | group | MAA | 1 | 1 | 1 | 1 |
| | | containing | | | | | |
| | | methacrylic | | | | | |
| | | acid | | | | | |
| | | (D)Alkene-based | SM | 10 | 10 | 10 | 10 |
| | | unsaturated group | IBOMA | 3 | 3 | 3 | 3 |
| | | containing methyl | | | | | |
| | | acrylate | | | | | |

| | | | | | |
|---|---|---|---|---|---|
| Second | Deionized water | 28 | 28 | 28 | 28 |
| hydrophilic | Hydrophilic initiator SPS | 0.2 | 0.2 | 0.2 | 0.2 |
| initiator | | | | | |

*In Table 1, MMA refers to methyl methacrylate, n-BMA refers to n-butyl methacrylate, BA refers to butyl acrylate, AA refers to acrylic acid, MAA refers to methacrylic acid, and IBOMA refers to isobornyl methacrylate.

### Solvent Resistance Test

The resistance to acetone solvent is tested in the following mariner An electric friction decoloring machine is provided, which includes a clamp at a lower position and a friction head at a higher position. A sample of a tested film in a size of 9 cm×18 cm is fixed to the clamp. A white cotton cloth impregnated with acetone is fixed to the friction head, and is used to wipe the sample for ten times with a load of 1 kg. Afterwards, it is observed whether or not the sample shows any abnormality (e.g., discoloration and deterioration).

TABLE 2

| | | | | | Comparative |
|---|---|---|---|---|---|
| Test result | | Embodiment 1 | Embodiment 2 | Embodiment 3 | Embodiment 1 |
| Resin | Color | Milky white | Milky white | Milky white | Milky white |
| | appearance | | | | |
| | Solid | 43 | 43 | 43 | 43 |
| | content (%) | | | | |
| | Average | 135 | 131 | 132 | 138 |
| | particle (nm) | | | | |
| Test | Resistance | Normal | Normal | Normal | Flawed/scratched |
| results | to abrasion | | | | |
| | under acetone | | | | |

### Beneficial Effects of the Embodiments

In conclusion, one of the beneficial effects of the present disclosure is that, the polymeric composition can be used to form an aqueous acrylic resin that has better solvent resistance through bonding the epoxy-containing silane and reactive emulsifier to acrylic polymer, and the addition of the functional reactive monomers.

Furthermore, compared with the polymeric composition containing alkoxy-containing silane (which has poor acetone solvent resistance), in the polymeric composition, the aqueous acrylic resin having high solvent resistance, and the method for manufacturing the same provided by the present disclosure, an aqueous acrylic resin having improved solvent resistance can be formed through bonding the epoxy-containing silane and the reactive emulsifier to an acrylic polymer and adding functional reactive monomers. Moreover, the aqueous acrylic resin can be used in the production of the synthetic leathers, so as to reduce the emission of volatile organic compounds (VOC), and to meet physical property requirements of the synthetic leathers.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A polymeric composition, which is used for forming an aqueous acrylic resin having high solvent resistance, the polymeric composition comprising:
an acrylic monomer polymer;
an epoxy-containing silane; and
a reactive emulsifier;
wherein a weight ratio of the acrylic monomer polymer, the epoxy-containing silane and the reactive emulsifier is 100:1:3;
wherein the epoxy-containing silane is selected from the group consisting of (3-glycidoxypropyl) trimethoxy silane, (3-glycidoxy propyl) methyl diethoxy silane, 2-(3, 4-epoxycyclohexyl) ethyl trimethoxy silane, (3-glycidoxy propyl) methyl dimethoxy silane, and (3-glycidoxy propyl) triethoxy silane.

2. The polymeric composition according to claim 1, wherein the epoxy-containing silane is (3-glycidoxypropyl) trimethoxy silane, (3-glycidoxy propyl) methyl diethoxy silane, or both.

3. The polymeric composition according to claim 1, wherein, based on 100 wt % of the acrylic monomer polymer, the acrylic monomer polymer includes:
55 to 65 wt % of alkyl group-containing methyl acrylate;
20 to 30 wt % of hydroxyl group containing methyl acrylate;
1 to 5 wt % of carboxyl group containing methacrylic acid; and
8 to 18 wt % of alkene-based unsaturated group containing methyl acrylate.

4. The polymeric composition according to claim 1, wherein the alkyl group-containing methyl acrylate is selected from the group consisting of methyl methacrylate, ethyl acrylate, propyl methacrylate, butyl acrylate, isobutyl methacrylate, pentyl methacrylate, hexyl methacrylate, heptyl methacrylate, octyl methacrylate, 2-ethylhexyl methacrylate, n-octyl methacrylate, iso-octyl methacrylate, nonyl methacrylate, decyl methacrylate, lauryl methacrylate, octadecyl methacrylate, methoxyethyl methacrylate, n-butyl methacrylate, 2-ethylhexyl acrylate, and ethoxymethyl acrylate.

5. The polymeric composition according to claim 1, wherein the hydroxyl group containing methyl acrylate is selected from the group consisting of 2-hydroxyethyl (meth)acrylate, 4-hydroxybutyl (meth)acrylate, 2-hydroxypropyl chloroacrylate and diethylene glycol mono(meth)acrylate.

6. The polymeric composition according to claim 1, wherein the carboxyl group containing methacrylic acid is selected from the group consisting of acrylic acid, methacrylic acid, maleic acid, fumaric acid, itaconic acid, butenoic acid, and maleic anhydride.

7. The polymeric composition according to claim 1, wherein the alkene-based unsaturated group containing methyl acrylate is selected from the group consisting of vinyl acetate, styrene, methyl styrene, vinyl toluene, methacrylonitrile, diacetone acrylamide, N-hydroxymethyl acrylamide, cyclohexyl methacrylate, and isobornyl methacrylate.

8. An aqueous acrylic resin having high solvent resistance, comprising the polymeric composition as claimed in claim 1.

9. A method for manufacturing an aqueous acrylic resin having high solvent resistance, comprising:
forming a starting reactant in a reaction tank, the starting reactant including deionized water, a buffer and an emulsifier;
forming a pre-emulsion including an acrylic monomer polymer, an epoxy-containing silane and a reactive emulsifier in a weight ratio of 100:1:3; and
adding the pre-emulsion to the starting reactant to carry out a reaction.

10. The method according to claim 9, further comprising: maintaining a temperature of the reaction tank at 70° C. to 80° C., and adding a hydrophilic initiator in the reaction tank.

11. The method according to claim 9, wherein the buffer is sodium bicarbonate or ammonium bicarbonate, and the emulsifier is sodium dodecylbenzene sulfonate.

12. The method according to claim 9, wherein, in the step of adding the pre-emulsion to the starting reactant to carry out the reaction, a temperature under which the step is performed is from 70° C. to 80° C., and the pre-emulsion is added in a dropwise manner.
